(19) United States
(12) Patent Application Publication
(10) Pub. No.: US 2008/0259050 A1
(43) Pub. Date: Oct. 23, 2008

(54) Optical touch control apparatus and method thereof

(75) Inventors: Cho-Yi Lin, HsinChu (TW); Yao-Ching Hsu, HsinChu (TW)

Correspondence Address: Tung & Associates, Suite 120, 838 W. Long Lake Road, Bloomfield Hills, MI, 48302, US

(73) Assignee: PixArt Imaging Incorporation

(21) Appl. No.: 11/737,899

(22) Filed: Apr. 20, 2007

(51) Int. Cl. G06F 3/033

(52) U.S. Cl. 345/175

(57) ABSTRACT

The present invention discloses an optical touch control apparatus, comprising: a light guide module having a screen, the light guide module guiding light to the screen, and generating optical information according to light input through or reflected from the screen; and an image sensor module for sensing the optical information, and generating an electronic signal according to the optical information.

### FIELD OF THE INVENTION

The present invention relates to an optical touch control apparatus which generates a control signal by optically detecting the movement of an input device, and a method thereof.

### BACKGROUND OF THE INVENTION

Touch-control apparatuses have become widely used in many applications, such as touchpad in a notebook computer, touch screen in an automatic teller machine, touch panel in a PDA or an electronic dictionary, etc. Presently there are resistance-type and capacitance-type touch control apparatuses. A resistance-type touch control apparatus senses the touched position by voltage drop; when its screen is touched, a circuit is conducted which results in a voltage drop in the horizontal axis and a voltage drop in the vertical axis. The amounts of the voltage drops are different depending on the touched position, and therefore the x-y coordinates of the touched position may be obtained. A capacitance-type touch control apparatus includes an ITO (Indium Tin Oxide) glass substrate. A uniform electric field is formed over its surface by discharging from its corners. When a conductive object, such as a human finger, conducts current away from the electric field, the lost amount of current may be used to calculate the x-y coordinates of the touched position.

### SUMMARY

An object of the present invention is to provide a novel optical touch control apparatus which is neither resistance-type nor capacitance-type; it detects the movement of an input device by an optical approach. Thus, the input device does not have to exert pressure on a screen or a pad, nor does it have to be conductive. In addition, no complicated manufacturing process is required; the cost of the touch control apparatus according to the present invention is much lower than that of a resistance-type or capacitance-type touch control apparatus.

Another object of the present invention is to provide a method for controlling a touch control apparatus.

To achieve the above and other objects, and as disclosed by one embodiment of the present invention, an optical touch control apparatus comprises: a light guide module having a screen, the light guide module guiding light to the screen, and generating optical information according to light input through or reflected from the screen; and an image sensor module for sensing the optical information, and generating an electronic signal according to the optical information.

Preferably, the optical touch control apparatus comprises an infrared light source. Also preferably, a lens module is interposed between the light guide module and the image sensor module. Moreover, the optical touch control apparatus may further comprise a feedback control circuit which controls illumination of the light source according to the optical information generated by the light guide module. Preferably, the electronic signal generated by the image sensor module may be processed by a processor circuit to generate an output signal for controlling a cursor, or for providing other functions, or for generating three-dimensional information.

In addition, according to another embodiment of the present invention, a method for controlling an optical touch control apparatus comprises: providing a light guide module having a screen; causing the light guide module to generate optical information according to light input through or reflected from the screen; and sensing the optical information, and generating an electronic signal according to the optical information.

### BRIEF DESCRIPTION OF THE DRAWINGS

These and other features, aspects, and advantages of the present invention will become better understood with reference to the following description, appended claims, and accompanying drawings.

FIG. 1 shows a first embodiment according to the present invention.

FIG. 2 explains how to calculate three-dimensional information.

FIG. 3 shows a second embodiment according to the present invention.

### DESCRIPTION OF THE PREFERRED EMBODIMENTS

The drawings of the present invention are for illustrative purpose only; they are not drawn according to actual scale. It is intended for these drawings to show the functional relationship among the devices, rather than physical shape and structure. The optical touch control apparatus according to the present invention may be applied to touchpad, touch panel, touch screen, and other applications. As a matter of fact, for the optical touch control apparatus of the present invention to work, it does not require “touching”. The term “touch control apparatus” is used in the context of the specification to imply that the present invention provides an alternative for the conventional touch control apparatus. It does not mean that the apparatus according to the present invention detects the position of an input device by its touching.

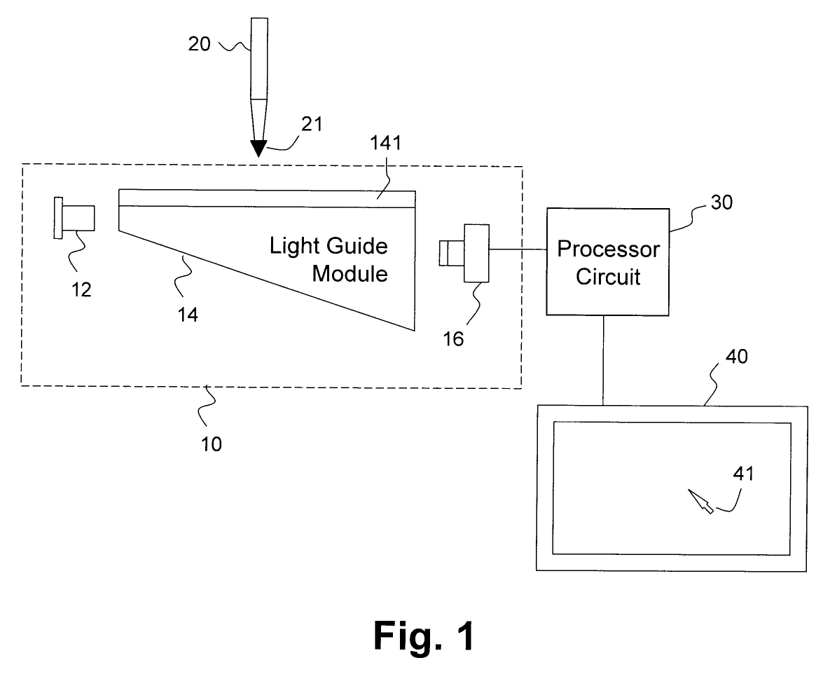

Referring to FIG. 1, the optical touch control apparatus 10 according to the present invention basically comprises a light source 12, a light guide module 14, and an image sensor module 16. Where necessary, an input device 20 is provided outside the touch control apparatus 10. The input device 20 may be any object such as a finger, a pen-shape object, or the like. It does not have to be a dedicated component of the touch control apparatus, nor does it have to be conductive. The light source 12 projects light into the light guide module 14. The light source 12 may be arranged at any suitable location other than the location shown in the figure, such as on top of the touch screen 141. The light source 12 may even be omitted if there is enough natural light. However, preferably, an infrared light source 12 is provided for stability of the performance. The light guide module 14 transmits the optical information of the movement of the input device 20 to the image sensor module 16. A light guide may be made by plastic injection molding technique, ink-jet technique, or imprint technique, as well known by those skilled in this art, the details of which are omitted here. In brief, the light guide module 14 includes a light guide (not shown) which transforms the linear light projected from the light source 12 into planar light, and projects the planar light uniformly to the touch screen 141. In addition, the light guide module 14 transmits light input through, or reflected from the touch screen 141 to the image sensor module 16, so that the image sensor module 16 may capture optical information relating to the movement of the input device 20. Preferably, the front end 21 of the input device 20 may be made of, or covered by a reflective material, so that the optical information captured by the image sensor module 16 is more accurate.

The image sensor module 16 transfers the optical information into electronic signals and sends the signals to a processor circuit 30. Depending on the application of the optical touch control apparatus 10, the output signals of the processor circuit 30 may be used to provide different functions, such as to control curser 41 movements on a display screen 40, when the optical touch control apparatus 10 is used as a touchpad in a notebook computer; or, to initiate an electronic transaction such as fund transfer, when the optical touch control apparatus 10 is used as a touch screen in an automatic teller machine.

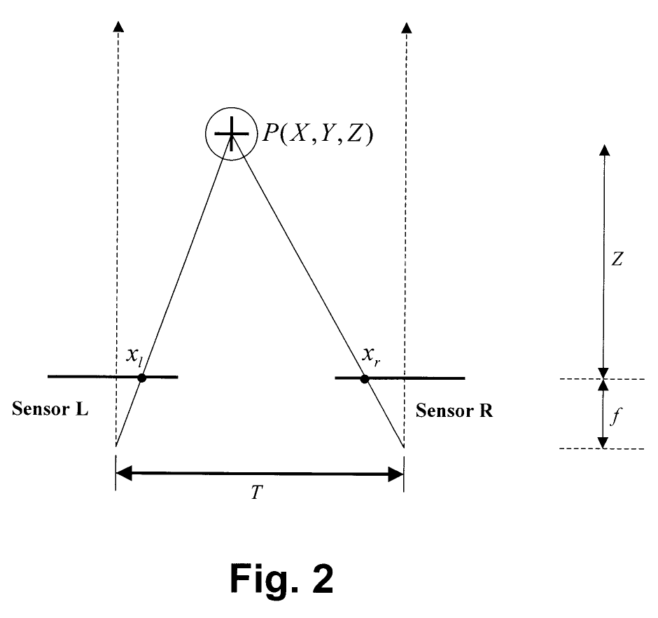

The optical information captured by the image sensor module 16 is two-dimensional; this is sufficient for controlling the movements of the cursor 41. However, if it is desirous to provide other functions according to the three-dimensional movement of the input device 20, such as to select an option from a menu displayed on a screen, it can be arranged as follows. Two or more image sensors can be provided in the image sensor module 16, and the three-dimensional movement of the input device 20 can be obtained from the captured images, the relative distance between two image sensors, and the focal distance of the image sensors. More specifically, as shown in FIG. 2, assuming that the distance between the center locations of the two image sensors is T; the focal distance of each of the image sensors is f; the captured image includes an object, and the object's horizontal position as seen from the left sensor is Xl, while its horizontal position as seen from the right sensor is Xr (Xr is a negative value since it is located at the left side of the right sensor); and the projected distance between the object and each of the sensors is Z; it can thus be obtained that

xₗ/f=X/Z, and −xᵣ/f=(T−X)/Z

Thus, the coordinates of the object can be obtained as:

X=(T×xₗ)/(xₗ−xᵣ)

Y=(T×yₗ)/(xₗ−xᵣ) ( wherein yₗ is not shown in the figure)

Z=f×[T/(xₗ−xᵣ)

It should be noted that the above is only one among many possible ways to calculate the three-dimensional information of the input device 20. The calculation of the three-dimensional information may be done by other ways, as those skilled in this art may conceive under the teaching by the present invention. The key point is that the present invention provides one more dimension, and thus more functions that can be achieved, as compared with the conventional touch control apparatus.

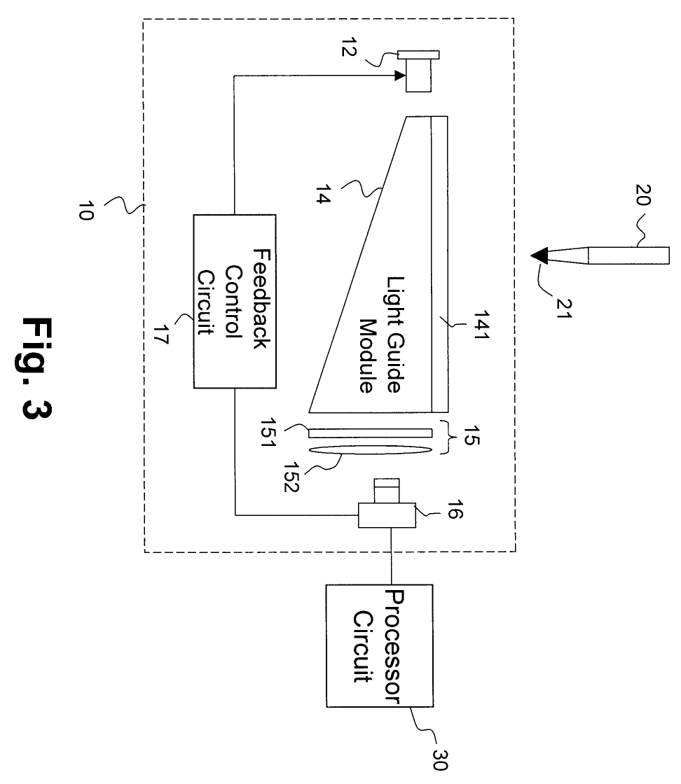

Referring to FIG. 3 which is another embodiment according to the present invention, the optical touch control apparatus 10 according to this embodiment comprises, in addition to the light source 12, the light guide module 14, and the image sensor module 16, a lens module 15 and a feedback control circuit 17. The lens module 15 includes one or more lenses 151, 152, to assist the image sensor module 16 to capture an image more precisely. The feedback control circuit 17 adjusts the illumination of the light source 12. When the light sensed by the image sensor module 16 is too weak that the captured image is not clear enough, the feedback control circuit 17 automatically adjusts the illumination of the light source 12 according to the condition of the image sensor module 16.

The spirit of the present invention has been explained in the foregoing with reference to its preferred embodiments, but it should be noted that the above is only for illustrative purpose, to help those skilled in this art to understand the present invention, not for limiting the scope of the present invention. Within the same spirit, various modifications and variations can be made by those skilled in this art. For example, additional devices may be interposed between any two devices shown in the drawings; the processor circuit 30, although shown as an external device to the optical touch control apparatus 10, may be integrated into the optical touch control apparatus 10; the input signal of the feedback control circuit 17 may come from the processor circuit 30 instead of the image sensor module 16, etc. In view of the foregoing, it is intended that the present invention cover all such modifications and variations, which should interpreted to fall within the scope of the following claims and their equivalents.

What is claimed is:

1. An optical touch control apparatus, comprising:
a light guide module having a screen, the light guide module guiding light to the screen, and generating optical information according to light input through or reflected from the screen; and
an image sensor module for sensing the optical information, and generating an electronic signal according to the optical information.

2. The apparatus as claimed in claim 1, further comprising a light source, and wherein the light guide module guides light projected from the light source to the screen.

3. The apparatus as claimed in claim 2, wherein said light source is an infrared light source.

4. The apparatus as claimed in claim 1, wherein said electronic signal is sent to a processor circuit.

5. The apparatus as claimed in claim 4, wherein said processor circuit generates three-dimensional information.

6. The apparatus as claimed in claim 1, further comprising an input device which includes a portion made of a reflective material.

7. The apparatus as claimed in claim 1, further comprising a lens module interposed between the light guide module and the image sensor module.

8. The apparatus as claimed in claim 1, further comprising a feedback control circuit which controls illumination of the light source according to the optical information generated by the light guide module.

9. The apparatus as claimed in claim 8, wherein said feedback control circuit receives signals from the image sensor module or from the processor circuit.

10. A method for controlling an optical touch control apparatus, comprising:
providing a light guide module having a screen;
causing the light guide module to generate optical information according to light input through or reflected from the screen; and
sensing the optical information, and generating an electronic signal according to the optical information.

11. The method as claimed in claim 10, further comprising:
projecting infrared light to the light guide module.

12. The method as claimed in claim 11, further comprising:
generating a feedback signal according to the optical information, to control the illumination of the infrared light.

13. The method as claimed in claim 10, further comprising:
controlling a cursor on a display screen according to the electronic signal.

14. The method as claimed in claim 10, further comprising:
controlling three-dimensional information according to the electronic signal.

15. The method as claimed in claim 10, further comprising:
moving an input device on or above the screen of the light guide module, the input device being at least partially made of a reflective material.
